(19) United States
(12) Patent Application Publication
(10) Pub. No.: US 2008/0023384 A1
(43) Pub. Date: Jan. 31, 2008

(54) Self-powered settling and evaporation tank apparatus

(76) Inventor: Ricky Dale Patmore, Calgary (CA)

Correspondence Address: SUZANNAH K. SUNDBY;SMITH, GAMBRELL & RUSSEL, LLP, 1130 Connecticut Avenue, NW, Suite 1130, WASHINGTON, DC, 20036, US

(21) Appl. No.: 11/494,500

(22) Filed: Jul. 28, 2006

(51) Int. Cl. B01D 35/18

(52) U.S. Cl. 210/180

(57) ABSTRACT

An apparatus for cleaning contaminated water and evaporating the produced cleaned water, comprising heat exchange means within an evaporation region of the apparatus.

### FIELD OF THE INVENTION

The present invention relates to treatment of contaminated water, and more particularly to water treatment through settling and evaporation.

### BACKGROUND OF THE INVENTION

Many industries generate contaminated water as a by-product of standard processes. For example, the oil and gas industry, both in exploration and production, employs numerous processes that result in substantial quantities of water contaminated by invert mud, dirt, soap or other undesirable substances. Disposal or processing of the contaminated water is a significant problem, and it has spawned a number of attempts to address the situation.

Evaporation tanks have been employed, with some limited success, in treating contaminated water in the oil and gas industry by evaporating the water and leaving a waste residue behind which must be gathered and disposed of. However, the common use of steam coils to cause the evaporation often results in undesirable build-up of contaminant on the coils themselves, resulting in cleaning difficulties. The large size required for some evaporation tank designs has made their use cost-prohibitive or presented space allocation issues, including the need for some tanks to be partially buried, and a lack of sufficient insulation in the tank walls has rendered some designs undesirable. Safety issues are also readily apparent in some proposed tank designs. Finally, the fact that most of the contaminant remains in the evaporation tank during evaporation means that an air contamination problem can arise when the water level approaches the heating element level.

What was needed was a safe and well-insulated water treatment apparatus that provided for efficient removal of contaminants from contaminated water and evaporation of the cleaned water, while also providing ease of cleaning or maintenance and a relatively small footprint. Canadian Patent Application No. 2,535,676, assigned to the present Applicant, was directed to such a water treatment apparatus, method and system. It taught an apparatus comprising a tank with a dividing member dividing the tank into a settling region and an evaporation region. The settling region comprised an inlet, weir means, and an outlet, and the evaporation region comprised an inlet and heat application means, the settling region outlet in fluid communication with the evaporation region inlet. The method comprised allowing contaminated water to encounter the weir means, producing contaminants and cleaned water, and transporting the cleaned water to the evaporation region, where the heat application means apply heat to the cleaned water allowing evaporation of the cleaned water. The water treatment system comprised a settling sub-system for receiving contaminated water from a source and allowing contaminants to settle out of the contaminated water, producing cleaned water, and an evaporation sub-system in fluid communication with the settling sub-system for receiving the cleaned water and enabling evaporation of the cleaned water. Preferably, the system further comprised a boiler blowdown sub-system in fluid communication with the evaporation sub-system, wherein an adjacent boiler is allowed to vent boiler contents into the evaporation sub-system during boiler blowdown. This provided numerous advantages over the prior art; for example, the settling region provided a “pre-tank” buffer zone for removing contaminants that would otherwise have entered the evaporation region of the tank, thereby addressing issues such as contaminant build-up on the heat application means as well as air contamination concerns, and evaporation rates could be improved by reducing the contaminant level in the water before it entered the evaporation region. However, it required close proximity to a boiler if boiler steam was employed as the heating element.

The need for close proximity to a substantial power or heat source has been a continuing problem in the field. As stated above, boiler-powered tanks require a boiler near enough to run steam lines, which is not always possible. Where electrical power is used (for example in electrical coils) to generate the necessary heat for evaporation purposes, the tanks become unfeasible as most commonly used drilling rigs cannot accommodate the power requirement.

What is still needed, therefore, is a safe and well-insulated water treatment apparatus that provides for efficient removal of contaminants from contaminated water and evaporation of the cleaned water, while also providing ease of cleaning or maintenance and a relatively small footprint, but provided with means to reduce or eliminate the dependency on substantial auxiliary power or heat sources that otherwise limit the application of such water treatment apparatus.

### SUMMARY OF THE INVENTION

The present invention accordingly seeks to provide a water treatment apparatus that meets these perceived needs.

According to the present invention, then, there is provided an apparatus for treating contaminated water comprising:
a base member;
a peripheral containment wall connected to the base member, the base member and peripheral containment wall defining a containment volume; and
a dividing member for dividing the containment volume into a settling region and an evaporation region;
the settling region comprising a settling region inlet, weir means, and a settling region outlet; and
the evaporation region comprising an evaporation region inlet and heat application means, the settling region outlet in fluid communication with the evaporation region inlet; and
the heat application means comprising:
   a heat source for positioning adjacent the peripheral containment wall; and
   heat exchange means within the evaporation region.

In exemplary embodiments of the present invention, the peripheral containment wall and the base member each preferably comprise inner and outer walls defining a space therebetween for receiving insulative material, and most preferably cross braces positioned in the space between the inner and outer walls. The settling region outlet and the evaporation region inlet preferably collectively comprise a cleaned water aperture in the dividing member spaced from the settling region inlet.

The weir means preferably comprise an inlet water deflector adjacent the settling region inlet and at least one weir member spaced from the inlet water deflector, and the at least one weir member is preferably supported from the peripheral containment wall and the dividing member and comprises at least one water transfer aperture for enabling passage of water from an upstream side of the weir member to a downstream side of the weir member.

The heat source preferably comprises heated air generation means, which most preferably comprise a fuel-powered heating unit, and the heat source further comprises at least one fuel tank. The heat exchange means preferably comprise heat transfer means and heat exchange tubing, the heat transfer means in communication with the heated air generation means and the heat exchange tubing, the heat exchange tubing in further communication with a heat exhaust stack for releasing excess heat and combustion products. The heat exchange tubing preferably comprises at least one heat retention member therein, which most preferably comprises a helical rod.

In exemplary embodiments, the base member is mounted on a skid to enable transport, and when the heat application means comprise a heat exhaust stack, the heat exhaust stack is preferably collapsible to enable transport. The heat source is most preferably mounted on the skid adjacent the base member. Where the heat source comprises a fuel-powered heating unit and at least one fuel tank, the fuel-powered heating unit and at least one fuel tank are preferably mounted on the skid adjacent the base member, such that the apparatus is self-powered and all elements can be transported together.

Exemplary embodiment of the apparatus may further comprise boiler blowdown means for releasing boiler contents into the containment volume. When such is the case, the boiler blowdown means preferably comprise boiler content inlet means adjacent the settling region for releasing the boiler contents into the settling region at a point downstream of the weir means.

Finally, the apparatus preferably further comprises an evaporation region outlet for selective release of evaporation region contents, most preferably comprising a ball valve and cam-lock.

As can readily be seen, a water treatment apparatus in accordance with the present invention can be self-powered and operate independently of substantial auxiliary power or heat sources. The use of a heat exchange system, particularly when the heat retention rods are incorporated (which enhances heating and reduces fuel costs), enables a heat source of much lesser power than is required for other commercially available evaporation units. An apparatus according to the present invention can be operated using a simple 110-volt power source (such as a small generator) to power the heat generation means, and approximately half of the fuel necessary when compared with concurrent running of a boiler to heat the evaporation tank contents.

An apparatus according to the present invention can also be provided with automatic shut-off means to shut down the heat application means when the evaporation region contents fall to a certain predetermined level. An apparatus according to the present invention could operate without operator oversight for a number of days depending on fuel supply. In addition, the apparatus can be skid-mounted, with no partial burying necessary, providing ease of transport and positioning, with a small footprint and reduced environmental impact.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 is a top plan view of a water treatment apparatus according to the present invention, with the grating removed to enable observation of the apparatus interior components;

FIG. 2 is a top plan view of the apparatus of FIG. 1 with the grating in place;

FIG. 3 is a rear elevation view of the apparatus;

FIG. 4 is a simplified top plan view of the apparatus interior;

FIG. 5 is a front elevation view of the apparatus;

FIG. 6 is a right side elevation view of the apparatus;

FIG. 7 is a sectional view along line A-A of FIG. 1;

FIG. 8 is a sectional view along line B-B of FIG. 1;

FIG. 9 is a detail view of the dividing member of the apparatus;

FIG. 10 is a detail view of weir members of the apparatus;

FIG. 11 is a top plan view of a skid for supporting the apparatus, illustrating placement of the heat generation means and fuel tanks;

FIG. 12 is a left side elevation view of the skid with the heat generation means and fuel tanks;

FIG. 13 is a rear elevation view of the skid with the heat generation means and fuel tanks;

FIG. 14 is a sectional view along line D-D of FIG. 11;

FIG. 15 is a sectional view along line C-C of FIG. 11;

FIG. 16 is a detail sectional view along line E-E of FIG. 2;

FIG. 17 is a detail view of area G of FIG. 1;

FIG. 18 is a detail view of area F of FIG. 3;

FIG. 19 is a detail section view of area L of FIG. 6;

FIG. 20 is a detail view of area H of FIG. 2;

FIG. 21 is a detail sectional view of area J of FIG. 5;

FIG. 22 is a detail view of area K of FIG. 7;

FIG. 23 illustrates detail top and side elevation views of a blowdown deflector;

FIG. 24 is a detail side elevation view of an inlet water deflector;

FIG. 25 illustrates detail rear and side elevation views of area N of FIG. 3;

FIG. 26 is a detail view of area P of FIG. 7; and

FIG. 27 illustrates side and rear elevation views of area T of FIG. 12.

### DETAILED DESCRIPTION OF EXEMPLARY EMBODIMENT

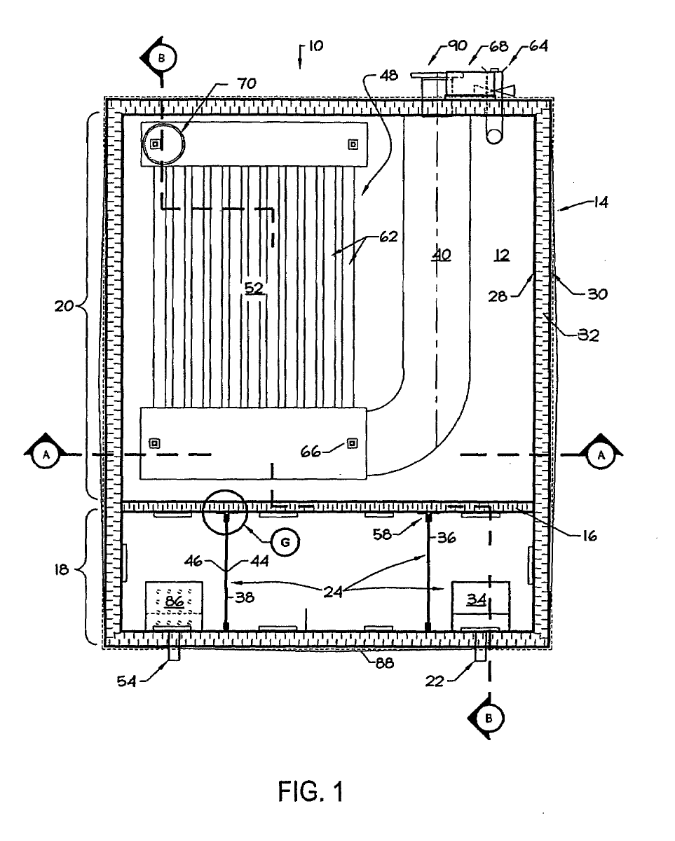

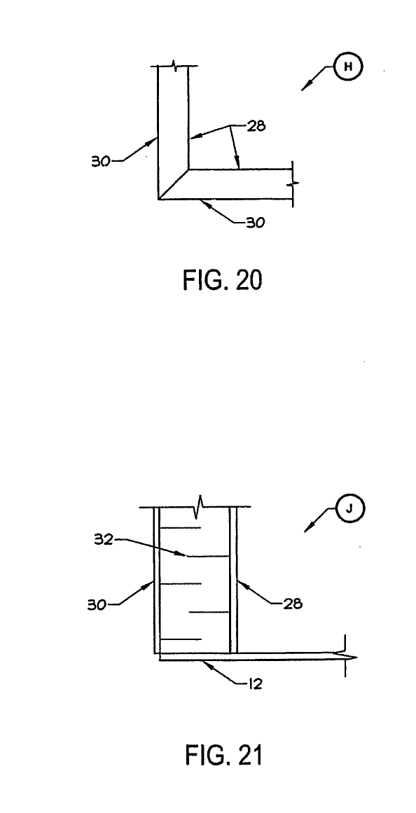

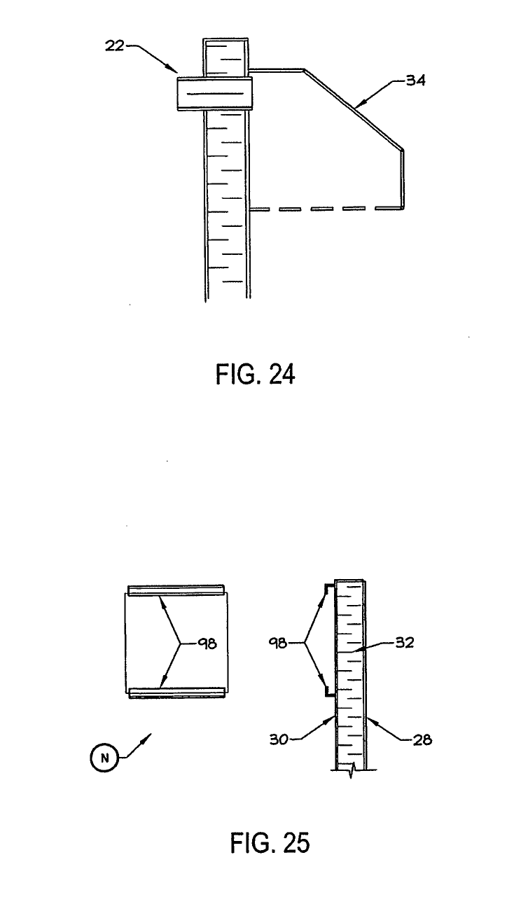

Referring now in detail to the accompanying drawings, there is illustrated an exemplary embodiment of a water treatment apparatus generally referred to by the numeral 10. Referring now to FIGS. 1, 20, 21 and 24, the water treatment apparatus 10 comprises a base member 12 and a peripheral containment wall 14, each preferably made of plate steel, which collectively contain and help define two distinct regions with distinct functionality with respect to contaminated water treatment, namely a settling region 18 and an evaporation region 20. The plate steel forming the peripheral containment wall 14 is most preferably bent and sheared to enhance structural strength, and the outer wall 30 is preferably painted a dark colour with metallic fragments incorporated to help absorb solar energy. The settling region 18 and evaporation region 20 are separated by a dividing member 16 which is also preferably made of plate steel and may comprise an inter-wall space for insulative material. The peripheral containment wall 14 comprises inner and outer walls 28, 30 which are spaced to allow for the presence of insulative material 32 (which is preferably a polyurethane insulation), and the outer wall 30 is provided with a gap to allow for the presence of cross braces 88.

The settling region 18 comprises a settling region inlet 22, in the illustrated embodiment a 2-inch-diameter pipe, which enables introduction of contaminated water (not shown) against an inlet water deflector 34. This inlet water deflector 34 directs the water downwardly to assist in causing contaminants (not shown) to settle out of the introduced contaminated water, prior to the water being processed by the weir members.

The weir means 24 within the settling region 18 comprise the inlet water deflector 34 and two weir members 36, 38. The water (not shown) is intended to pass over (or through, where there is a water transfer aperture 42, as described below) each of these weir members 36, 38 in series, again causing contaminants to settle out of the water. The cleaned water (not shown) will then exit the settling region 18 by means of a settling region outlet, which in this embodiment is a cleaned water aperture 26 in the dividing member 16 at a location downstream of the last weir member 38; this aperture 26 also functions as the first evaporation region inlet, as described below.

Referring now in detail to FIG. 10, the plate steel weir members 36, 38 each comprise a water transfer aperture 42 to enable the passage of water from the upstream side 44 of the weir member to the downstream side 46. In this preferred embodiment, each successive aperture 42 is slightly. larger, reflecting the fact that the water should be cleaner after it has passed a previous weir member and more water volume can accordingly be released toward the next weir member. In an alternative embodiment (not shown), each successive weir member can be slightly shorter (and the cleaned water would pass over the top of the weir member), again because the water has lost enough contaminants to allow a greater volume to more easily and quickly proceed toward the next weir member.

Each of the weir members 36, 38 are mounted within the settling region 18 by means of steel angle supports 58, which act as guide rails for positioning of the weir members. Referring in detail to FIGS. 1, 9 and 17, the angle supports 58 are fixedly attached to the dividing member 16, leaving a gap of sufficient size to receive and retain the weir member 36, 38 in a desired position between the settling region inlet 22 and the settling region outlet 26.

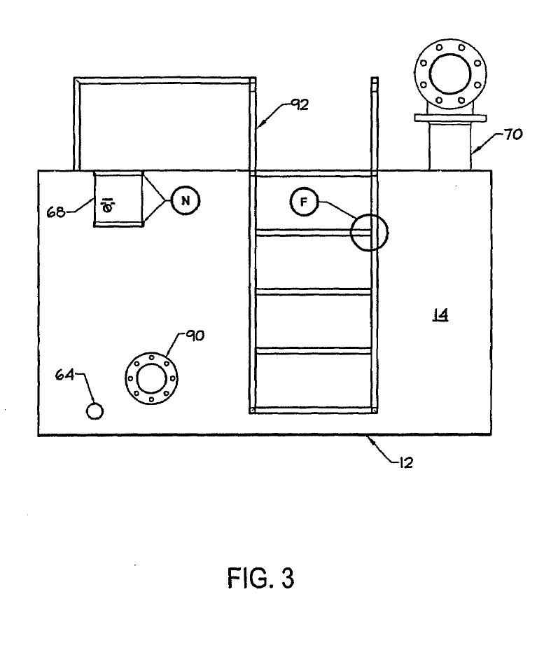

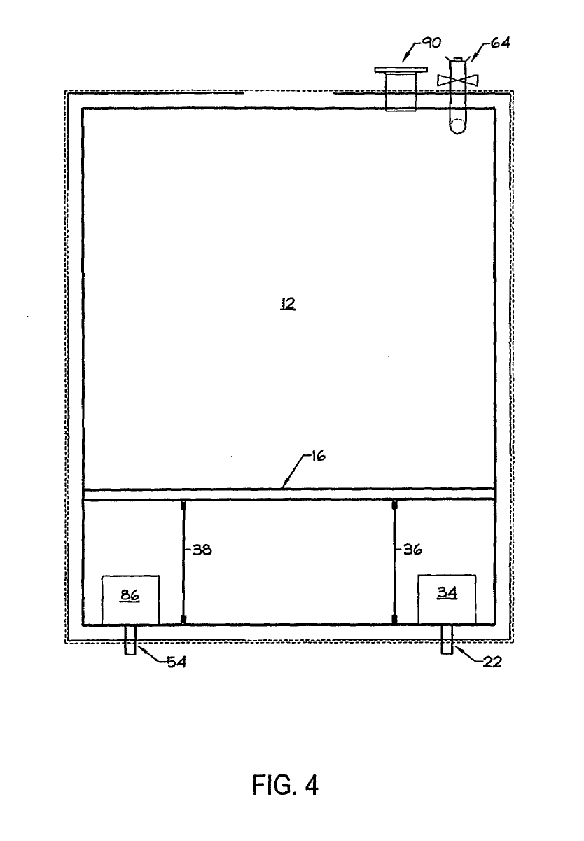

Referring now in detail to FIGS. 1, 3, 4, 6 and 8, the evaporation region 20 comprises a first evaporation region inlet—which, as described above, is the cleaned water aperture 26—and heat application means 48 (which are described in detail below). The evaporation region 20 receives cleaned water from the settling region 18 by means of the cleaned water aperture 26 in the dividing member 16, and the main purpose of the evaporation region 20 is to receive input fluid and subject it to heat to enable evaporation. The evaporation region 20 may also simply be selectively drained by means of the three-inch drainage outlet 64 which is provided with a ball valve control and cam lock.

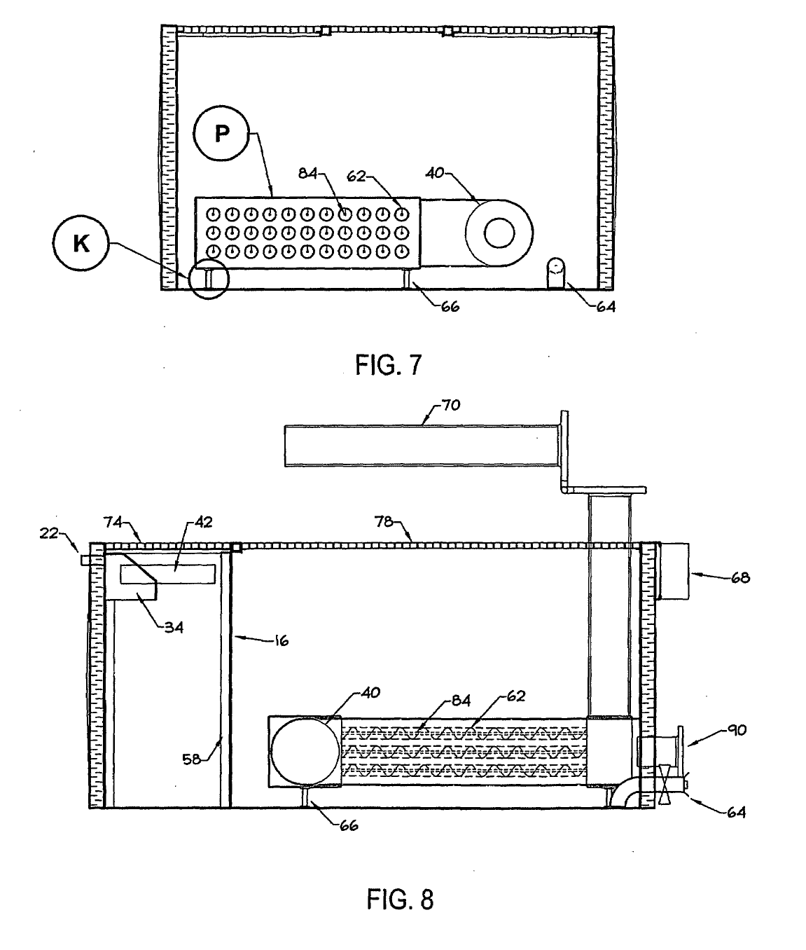

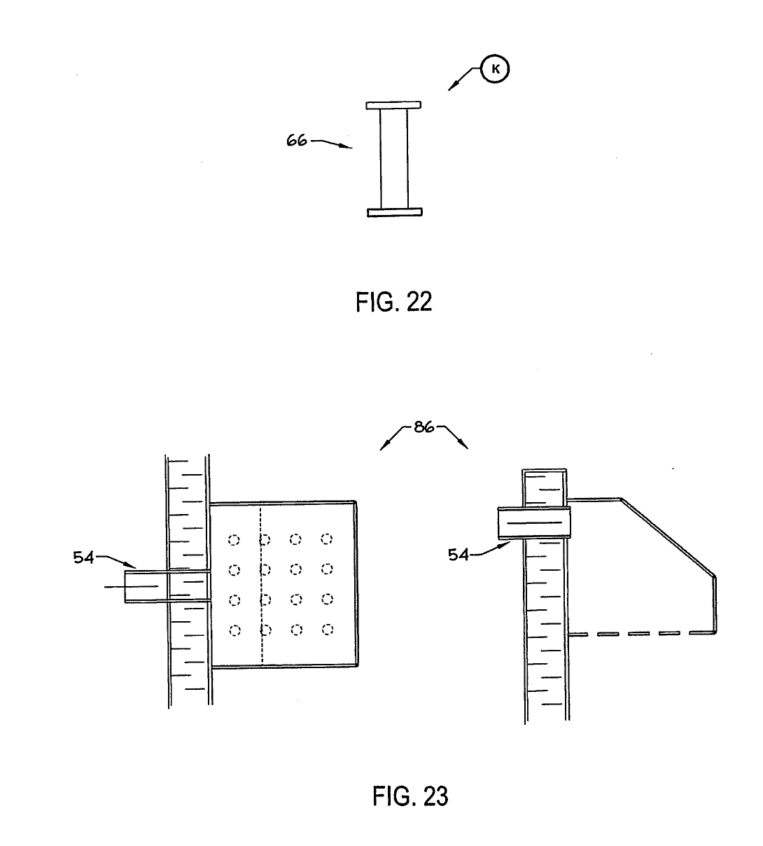

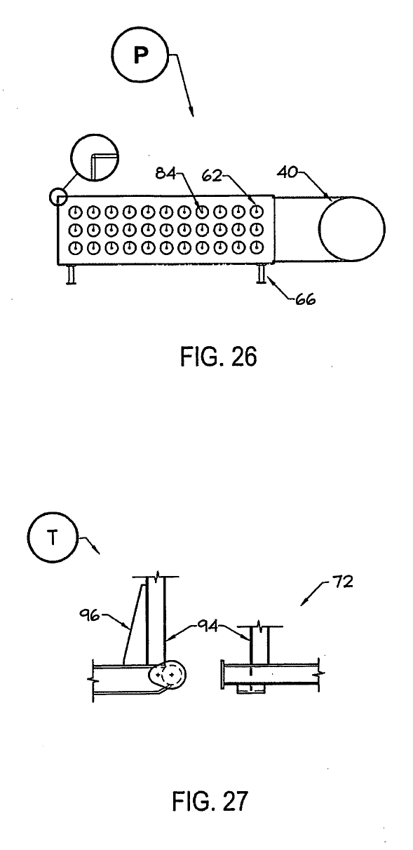

To enable heating of the evaporation region 20 contents, the exemplary embodiment of the apparatus 10 is provided with novel heat application means 48, illustrated in detail in FIGS. 1, 7, 8, 11 and 26. The heat application means 48 comprise a heat source 50 (which in the illustrated embodiment includes heated air generation means 56 and fuel tanks 60) and heat exchange means 52 The heat exchange means 52 comprise heat transfer means 40 and heat exchange tubing 62, which tubing 62 is made of light, thin steel (the type of tubing sometimes used with boilers). The heat exchange means 52 are supported by heat exchange supports 66, as illustrated in FIGS. 7, 8, 22 and 26, and the excess heat and combustion products are vented by means of an exhaust stack 70. As can be seen in FIGS. 6 and 8, the exhaust stack 70 is collapsible to enable transport, and the collapsible portion can even be removed if desired.

The heated air generation means 56 are in communication with the heat transfer means 40 through a flange connection 90. When heated air is generated by the heated air generation means 56, it passes through the heat transfer means 40 and thence into the heat exchange tubing 62, before venting through the stack 70. Each length of tubing 62 is provided with a heat retention member 84 therein, which in the exemplary embodiment is a helical rod. The heat retention member 84 retains some of the heat that would otherwise pass through the heat exchange means 52, enhancing the evaporative capacity of the apparatus 10 and reducing the power consumption needs of the apparatus 10. There are thirty-three lengths of tubing 62 in the exemplary embodiment, although someone skilled in the art would easily be able to arrive at modified configurations of equal utility.

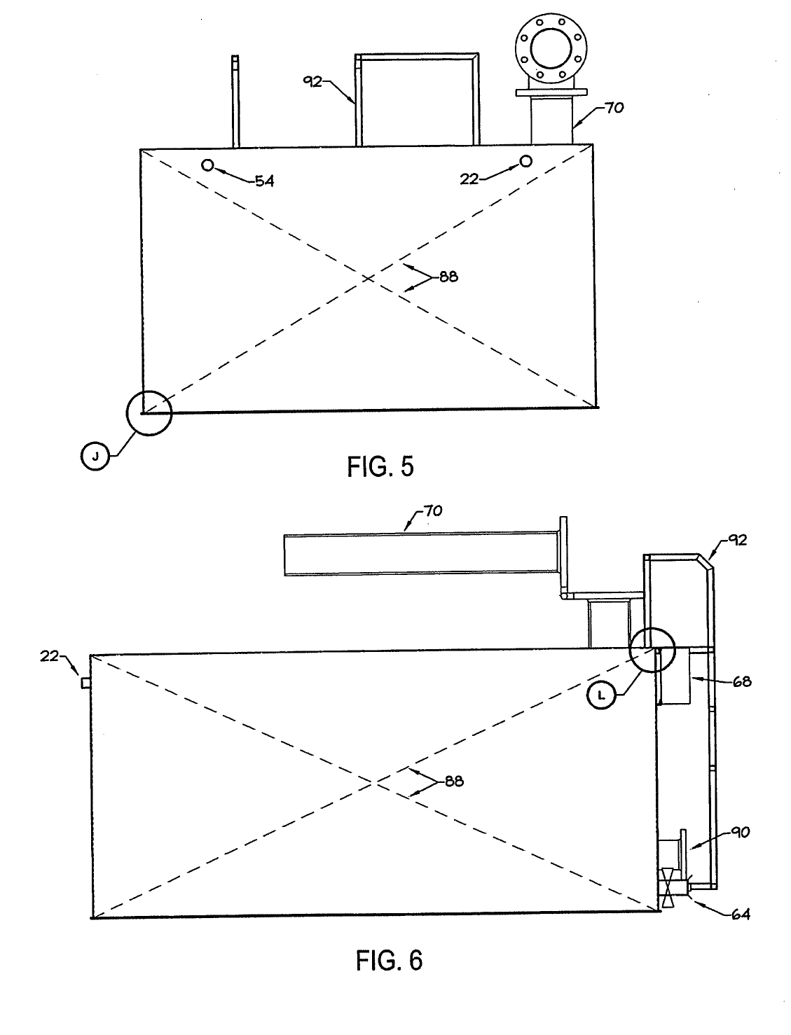

The exemplary embodiment of the apparatus 10 is configured to allow blowdown of boiler contents directly into the settling region 18, should such be desired. As can best be seen in FIGS. 1, 4, 5 and 23, there is a two-inch-diameter boiler blowdown inlet 54 which can receive boiler contents from an adjacent boiler. The inlet 54 is positioned adjacent a blowdown deflector 86, which deflects and directs the flow to enhance separation of any contaminants from the boiler contents. As boiler contents would generally be cleaner than other contaminated water entering the apparatus 10, they by-pass the weir means 24.

In addition, the exemplary embodiment of the apparatus 10 may incorporate a water level probe (not shown) to help prevent undesired over-evaporation of the evaporation region 20 contents, which might otherwise damage the heat exchange means 52. Such a water level probe, one of various known in the art, would be designed to automatically shut off power to the heated air generation means 56 when the water level drops to predetermined level, and the apparatus 10 would then also be provided with a reset button.

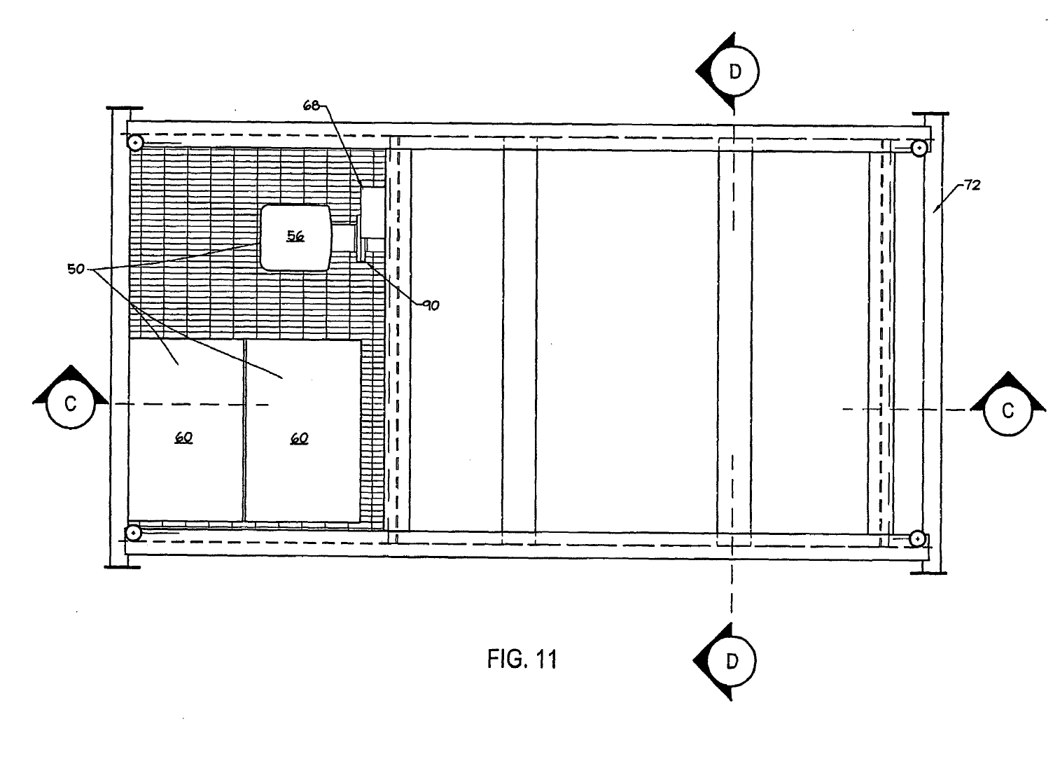

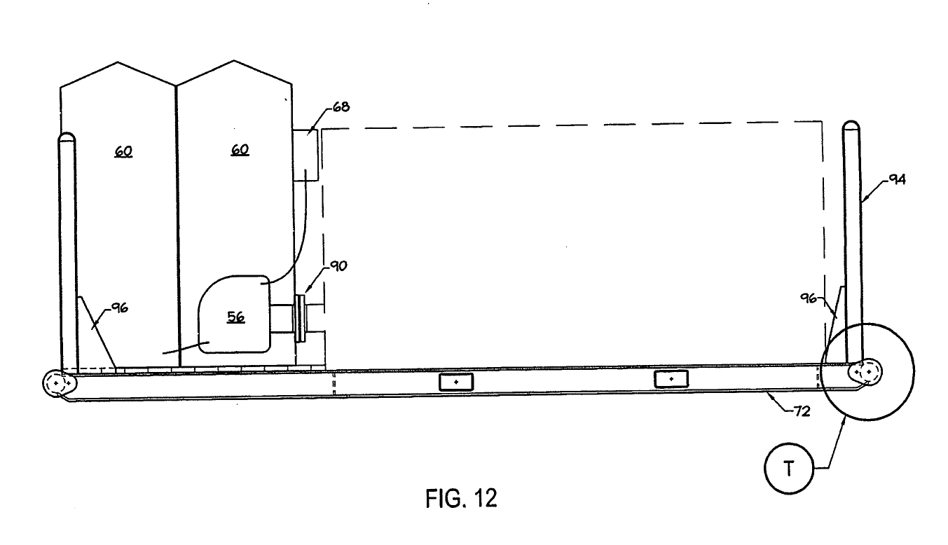

As can be seen in FIGS. 1, 3, 12 and 25, the apparatus 10 is also provided with an electrical junction or control box 68 to control electrical input, the box 68 attached to the peripheral wall 14 by means of a junction box mount 98.

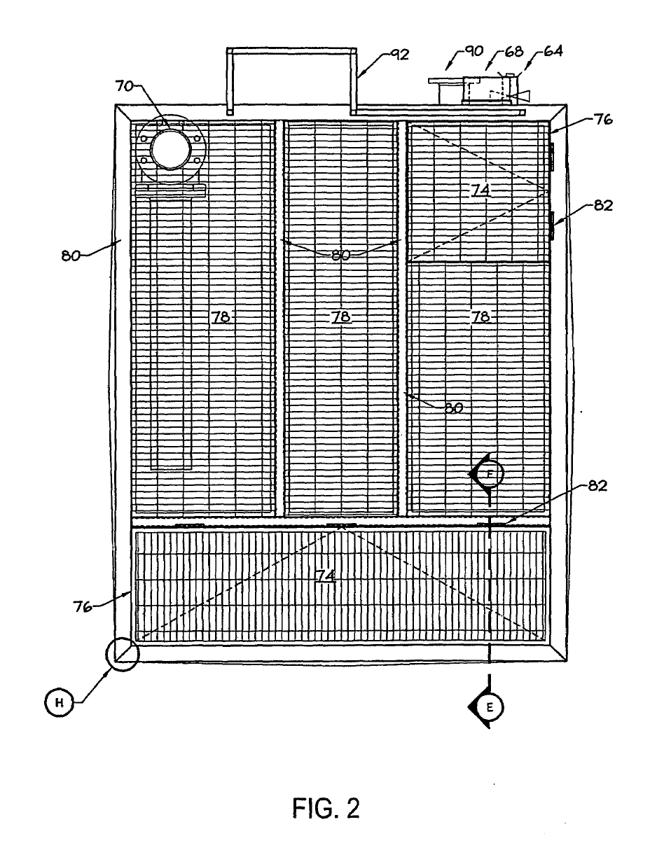

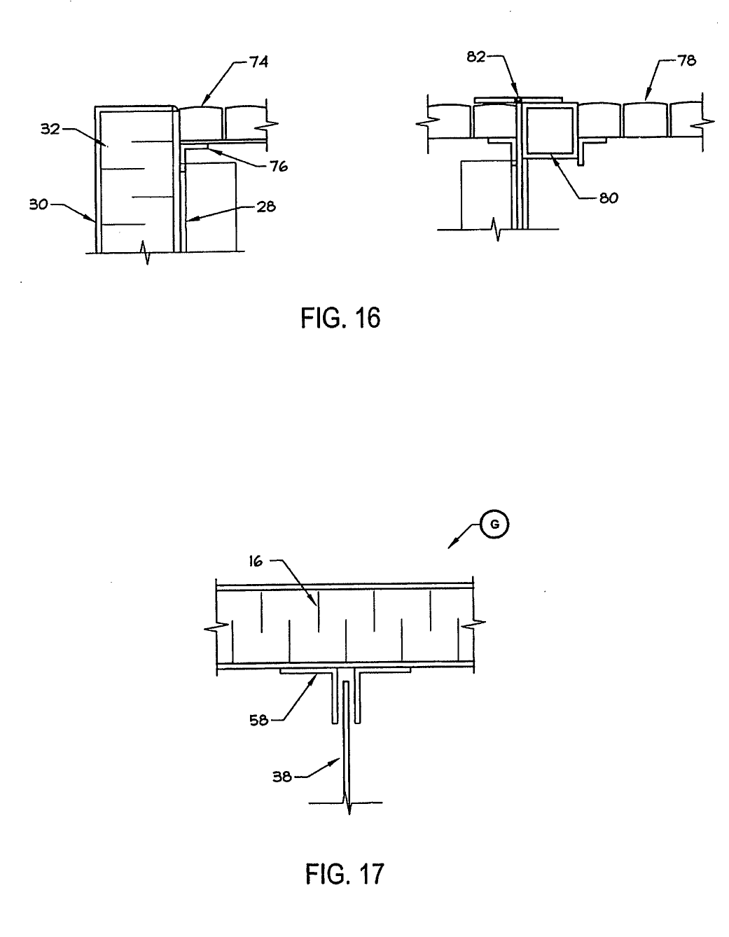

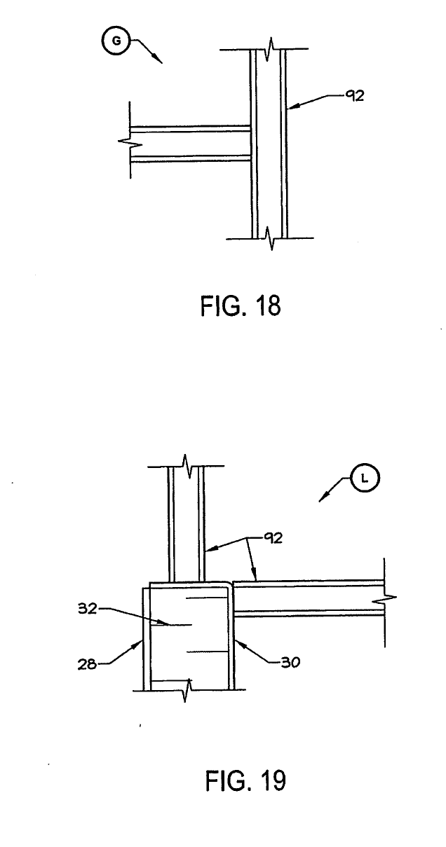

The exemplary embodiment of the apparatus 10 further comprises a cover for allowing a person to walk across the apparatus 10 and selectively clean it while being protected from the high-temperature contents, which cover is preferably flush with the top of the peripheral wall 14. Referring now in detail to FIGS. 2, 3, 16, 18 and 19, the cover comprises hatch grating 74 and walkway grating 78, composed of galvanized steel (so-called “grip-strut” grating). The hatch grating 74 is supported on hatch framing 76, and the various segments of the hatch framing 76 are pivotable about hinges 82 to enable access to selected areas of the settling and evaporation regions 18, 20 (to clean those areas, for example). The walkway grating 78 is supported on walkway framing 80, providing a stable surface for persons needing to walk across the surface of the apparatus 10. To enable access to the top of the apparatus 10, a ladder 92 is provided at the rear of the apparatus 10.

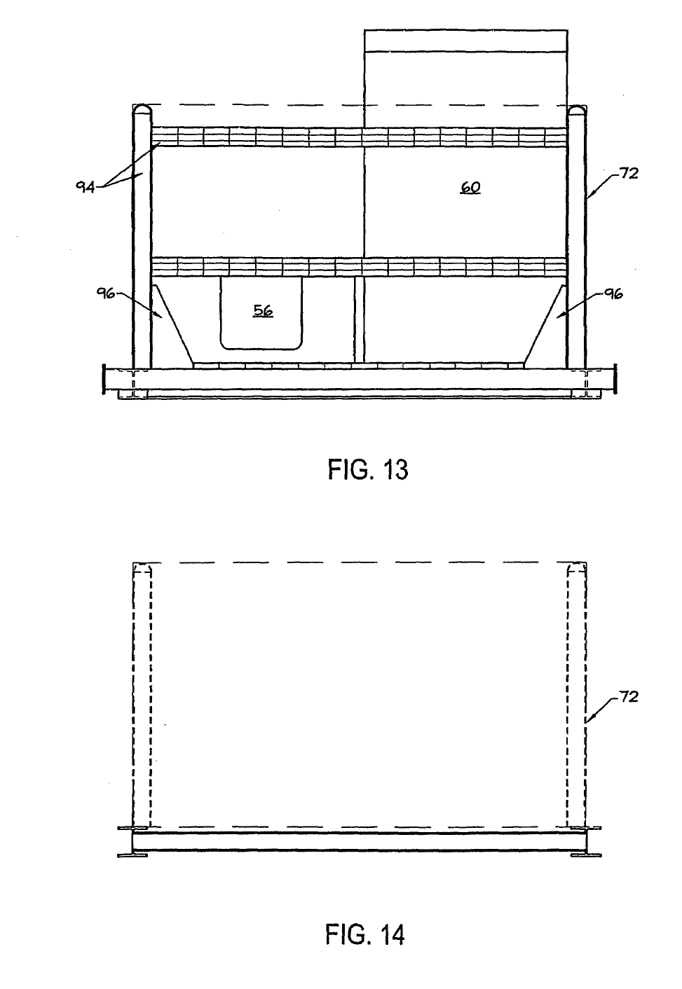

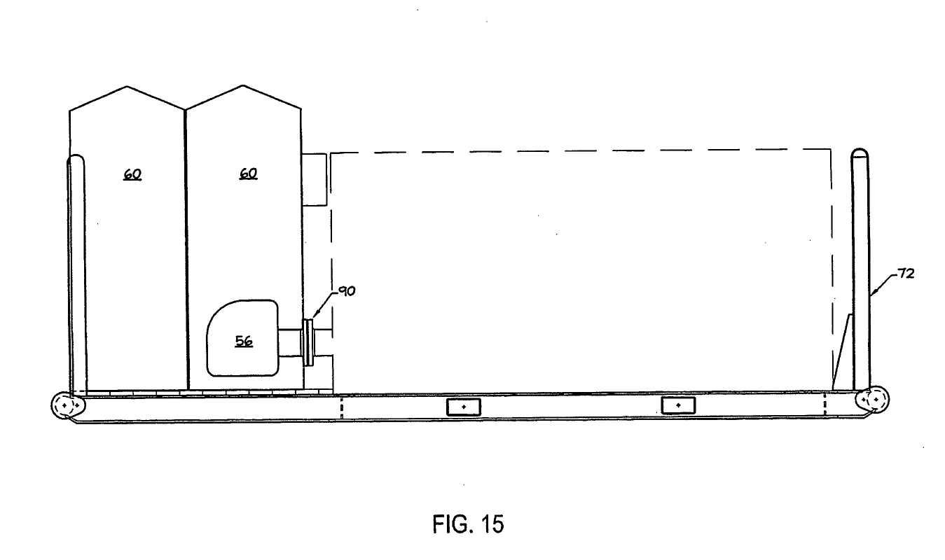

The exemplary embodiment of the apparatus 10 is configured to be received on a skid 72 for ease of transport. As can be seen in FIGS. 11 to 15 and 27, the skid 72 comprises railings 94 and stiffener plates 96 to enhance stability and safety. The skid 72 can receive both the apparatus 10 and the heat source 50, and the system is therefore self-powered and fully transportable. As mentioned above, a small 110-volt generator could also be transported with the skid 72, so the target destination need not even be provided with a power source.

The utility of the present invention is described in the following. To begin, the settling region inlet 22 of the apparatus 10 must be connected to a contaminated water source (not shown), and a line from an adjacent boiler may be connected to the boiler blowdown inlet 54 if desired.

Either before or after the line connections above, the heated air generation means 56 would need to be connected to the fuel tanks 60, the flange 90, and a 110-volt power source (not shown, but may be either an on-site power line or a small generator). The contaminated water is transported from the contaminated water source to the settling region 18, and the heated air generation means 56 can safely be engaged once cleaned water begins to fill the evaporation region 20.

When the contaminated water enters the settling region 18, it will be allowed to first encounter the inlet water deflector 34, which directs the contaminated water downwardly, assisting in settling out any contaminants (such as dirt, mud, soap or chemicals). The contaminated water will then encounter each of the weir members 36, 38 in series (where a plurality of weir members is employed), and this also helps to generate a separation of contaminants from now-cleaned water. At this point, the contaminants can either be allowed to accumulate in the settling region 18 or they can be extracted by using a vacuum truck or other suitable means; where the contaminant is lighter than water (e.g. invert mud) this should be extracted before it can move into the evaporation region.

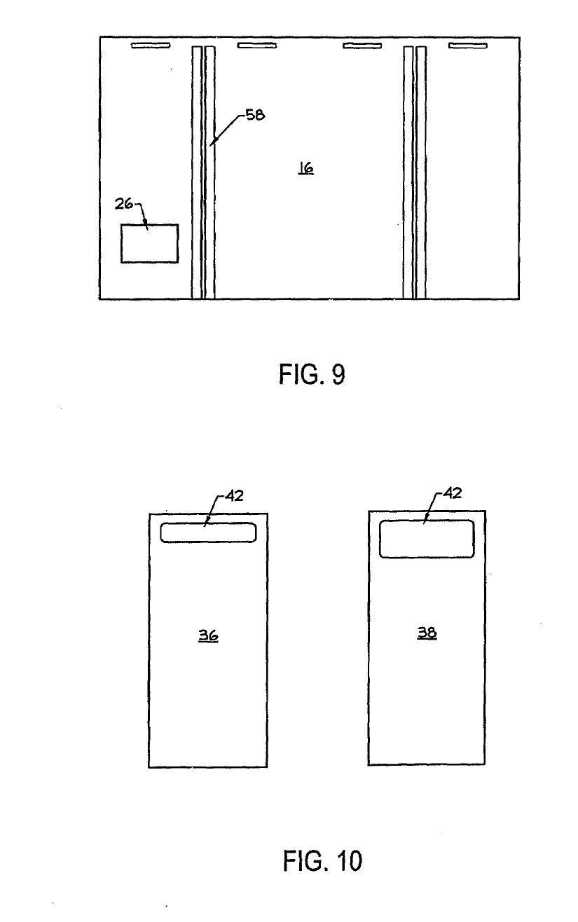

The cleaned water (and boiler blowdown fluid that has selectively been allowed to enter the settling region 18 downstream of the weir members 36, 38) is then transported into the evaporation region 20 for evaporation or draining. Where the apparatus 10 has a simple cleaned water aperture 26 in the dividing member 16, such as illustrated in FIG. 9, this transporting merely entails allowing the cleaned water to flow into the evaporation region 20.

At this point, the heated air generation means 56 can be powered up, generating heated air which is forced into the heat transfer means 40 and the heat exchange tubing 62, with exhaust through the stack 70. The heat exchange tubing 62 absorbs and radiates the heat received thereby, which heats the cleaned water adjacent the tubing 62, allowing evaporation of the cleaned water. The presence of heat retention members 84 serves to retain additional heat within the heat exchange means 52, further enhancing evaporation. The temperature can be raised to the point where the cleaned water comes to a boil, the rolling of the cleaned water contributing to the evaporation. One additional benefit of this heating is that the adjacent settling region 18 is also subjected to heat, which can assist in the settling process. It is possible to selectively release unevaporated cleaned water (if, for example, the volume of incoming fluid is too large for the evaporation region 20 capacity) by means of the drainage outlet 64.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

Embodiments of the invention in which an exclusive property or privilege is claimed are defined as follows:

1. An apparatus for treating contaminated water comprising:
a base member;
a peripheral containment wall connected to the base member, the base member and peripheral containment wall defining a containment volume; and
a dividing member for dividing the containment volume into a settling region and an evaporation region;
the settling region comprising a settling region inlet, weir means, and a settling region outlet; and
the evaporation region comprising an evaporation region inlet and heat application means, the settling region outlet in fluid communication with the evaporation region inlet; and
the heat application means comprising:
a heat source for positioning adjacent the peripheral containment wall; and
heat exchange means within the evaporation region.

2. The apparatus of claim 1 wherein the peripheral containment wall and the base member each comprise inner and outer walls defining a space therebetween for receiving insulative material.

3. The apparatus of claim 1 wherein the settling region outlet and the evaporation region inlet collectively comprise a cleaned water aperture in the dividing member spaced from the settling region inlet.

4. The apparatus of claim 1 wherein the weir means comprise an inlet water deflector adjacent the settling region inlet and at least one weir member spaced from the inlet water deflector.

5. The apparatus of claim 4 wherein the at least one weir member is supported from the peripheral containment wall and the dividing member and comprises at least one water transfer aperture for enabling passage of water from an upstream side of the weir member to a downstream side of the weir member.

6. The apparatus of claim 1 wherein the heat source comprises heated air generation means.

7. The apparatus of claim 6 wherein the heated air generation means comprise a fuel-powered heating unit, and the heat source further comprises at least one fuel tank.

8. The apparatus of claim 1 wherein the heat exchange means comprise heat transfer means in communication with heat exchange tubing.

9. The apparatus of claim 6 wherein the heat exchange means comprise heat transfer means and heat exchange tubing, the heat transfer means in communication with the heated air generation means and the heat exchange tubing, the heat exchange tubing in further communication with a heat exhaust stack for releasing excess heat and combustion products.

10. The apparatus of claim 1 wherein the base member is mounted on a skid to enable transport.

11. The apparatus of claim 10 wherein the heat application means comprise a heat exhaust stack, the heat exhaust stack collapsible to enable transport.

12. The apparatus of claim 10 wherein the heat source is mounted on the skid adjacent the base member.

13. The apparatus of claim 10 wherein the heat source comprises a fuel-powered heating unit and at least one fuel tank, the fuel-powered heating unit and at least one fuel tank mounted on the skid adjacent the base member.

14. The apparatus of claim 8 wherein the heat exchange tubing comprises at least one heat retention member therein.

15. The apparatus of claim 8 wherein the heat exchange tubing comprises at least one heat retention member therein, the at least one heat retention member comprising a helical rod.

16. The apparatus of claim 1 further comprising boiler blowdown means for releasing boiler contents into the containment volume.

17. The apparatus of claim 16 wherein the boiler blowdown means comprise boiler content inlet means adjacent the settling region for releasing the boiler contents into the settling region at a point downstream of the weir means.

18. The apparatus of claim 2 further comprising cross braces positioned in the space between the inner and outer walls.

19. The apparatus of claim 1 further comprising an evaporation region outlet for selective release of evaporation region contents.

20. The apparatus of claim 19 wherein the evaporation region outlet comprises a ball valve and cam-lock.
